(19) United States
(12) Patent Application Publication
(10) Pub. No.: US 2015/0355740 A1
(43) Pub. Date: Dec. 10, 2015

(54) TOUCH PANEL SYSTEM

(71) Applicant: SHARP KABUSHIKI KAISHA, Osaka-shi, Osaka (JP)

(72) Inventors: Manabu YUMOTO, Osaka-shi (JP); Shunsuke NAGASAWA, Osaka-shi (JP); Masayuki YAMAGUCHI, Osaka-shi (JP)

(73) Assignee: SHARP KABUSHIKI KAISHA, Osaka-shi, Osaka (JP)

(21) Appl. No.: 14/759,548

(22) PCT Filed: Dec. 27, 2013
(86) PCT No.: PCT/JP2013/085156

§ 371 Date: Jul. 7, 2015

(30) Foreign Application Priority Data
Jan. 9, 2013 (JP) 2013-002149

(51) Int. Cl. G06F 3/041

(52) U.S. Cl. CPC G06F 3/041

(57) ABSTRACT

A touch panel system includes a touch panel and a touch position detecting section for detecting a touch position on the touch panel. The touch position detecting section includes a touch position predicting section which sets predicted coordinates or a predicted range of a touch position based on a touch operation record, and predicts, based on the predicted coordinates or the predicted range, a touch position from touch position candidates detected by the touch position detecting section.

### TECHNICAL FIELD

The present invention relates to a touch panel system and an electronic device including the touch panel system. In particular, the present invention relates to (i) a touch panel system which can prevent erroneous recognition of a touch operation and (ii) an electronic device including the touch panel system.

### BACKGROUND ART

At present, applications of a touch panel system to various electronic devices, e.g., a mobile information device such as a smartphone and a vending machine such as a ticket bending machine, have rapidly been increased. A touch panel mainly used in such a touch panel system has been a resistive film type touch panel. However, in recent years, a projected capacitive type touch panel is becoming popular because of its capability of accepting multi-touch.

As an example of such a touch panel system, Patent Literature 1 discloses a command input device. The command input device includes a touch panel, a touch time detecting section, a touch frequency detecting section, a touch interval detecting section, and an input command determining section. The touch time detecting section detects time during which a finger is continuously making contact with the touch panel. The touch frequency detecting section detects the number of times that the finger touches the touch panel. The touch interval detecting section detects an interval from when the finger is off from the touch panel and to when the finger makes contact with the touch panel. The input command determining section determines an input command on the basis of detection results of the touch time detecting section, the touch frequency detecting section, and the touch interval detecting section.

FIG. 9 is a flowchart for describing an operation of the command input device disclosed in Patent Literature 1. As illustrated in FIG. 9, the command input device is arranged such that: (i) a command can be inputted on the basis of time, a frequency, and an interval of touch by the finger to the touch panel (S501 to 507); (ii) a command is determined on the basis of the inputted command (S508); (iii) an operation is selected on the basis of the determined command (S509); and (iv) the touch panel is controlled in accordance with the selected operation (S510).

### CITATION LIST

### Patent Literature

### [Patent Literature 1]

Japanese Patent Application Publication Tokukai No. 2004-362429 (Publication date: Dec. 24, 2004)

### SUMMARY OF INVENTION

### Technical Problem

However, a conventional touch panel system has a problem that the conventional touch panel system recognizes, as a touch position, noise which has occurred during a touch operation.

Specifically, the conventional touch panel system detects a touch position at every predetermined time so that a touch position (a current touch position) at a certain time point is recognized. Thus, in a case where noise has occurred on a touch panel, not only (i) a touch position that is supposed to be recognized but also (ii) a position of the noise is recognized as touch positions. As a result, noise which has occurred at a position far distant from a previous touch position is erroneously recognized as a touch position.

The command input device disclosed in Patent Literature 1 is intended to be applied to a car navigation device. The command input device determines an inputted command on the basis of continuous touch time, a touch frequency, and a touch time interval, with respect to the touch panel. From this, a driver does not need to look at the touch panel when inputting a command while driving, and the driver can accurately input a command even in a case where a vehicle is shaking. With the configuration, the command input device also erroneously recognizes, as a touch position, noise which has occurred at a position far distant from a previous touch position.

The present invention is attained in view of the above conventional problem. An object of the present invention is to provide a touch panel system and the like that can prevent erroneous recognition of a touch operation.

### Solution to Problem

In order to attain the object, the touch panel system in accordance with an aspect of the present invention includes: a touch panel; and a touch position detecting section for detecting a touch position on the touch panel, the touch position detecting section including: a touch position predicting section for (i) setting predicted coordinates or a predicted range of a touch position based on a touch operation record and (ii) predicting a touch position from touch position candidates, which have been detected by the touch position detecting section, based on the predicted coordinates or the predicted range.

### Advantageous Effects of Invention

According to one aspect of the present invention, it is possible to prevent erroneous recognition of a touch operation.

### BRIEF DESCRIPTION OF DRAWINGS

FIG. 1 is a view schematically illustrating a touch panel system according to Embodiment 1 of the present invention.

FIG. 2 is a block diagram illustrating a touch position predicting section of the touch panel system illustrated in FIG. 1.

FIG. 3 is a view illustrating a method of predicting coordinates of a touch position by the touch panel system illustrated in FIG. 1 based on a distance from a previous touch position.

FIG. 4 is a flowchart illustrating a process of the touch position predicting section of the touch panel system illustrated in FIG. 1.

FIG. 5 is a view schematically illustrating the process (coordinates predicting method) of the touch position predicting section of the touch panel system illustrated in FIG. 1.

FIG. 6 is a flowchart illustrating a process of the touch position predicting section of the touch panel system according to Embodiment 2 of the present invention.

FIG. 7 is a view schematically illustrating a process (coordinates predicting method) of the touch position predicting section of the touch panel system according to Embodiment 2 of the present invention.

FIG. 8 is a block diagram illustrating a configuration of a mobile phone according to Embodiment 4 of the present invention.

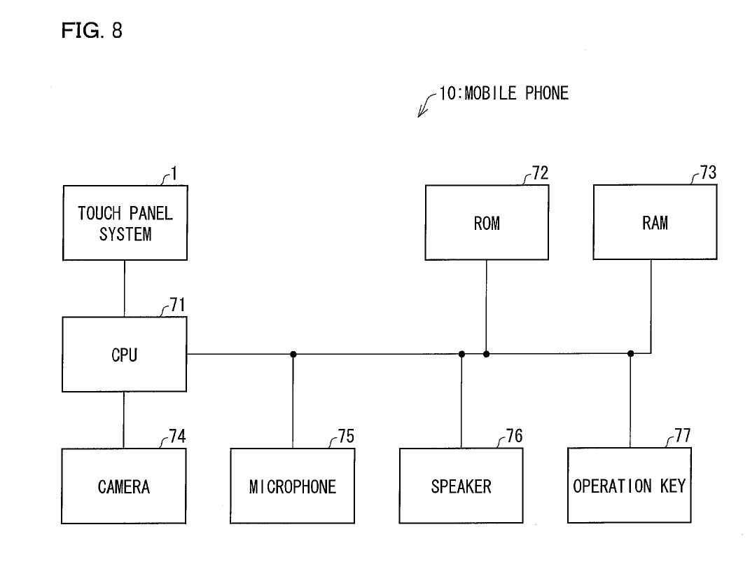

FIG. 9 is a flowchart for describing an operation of a command input device disclosed in Patent Literature 1.

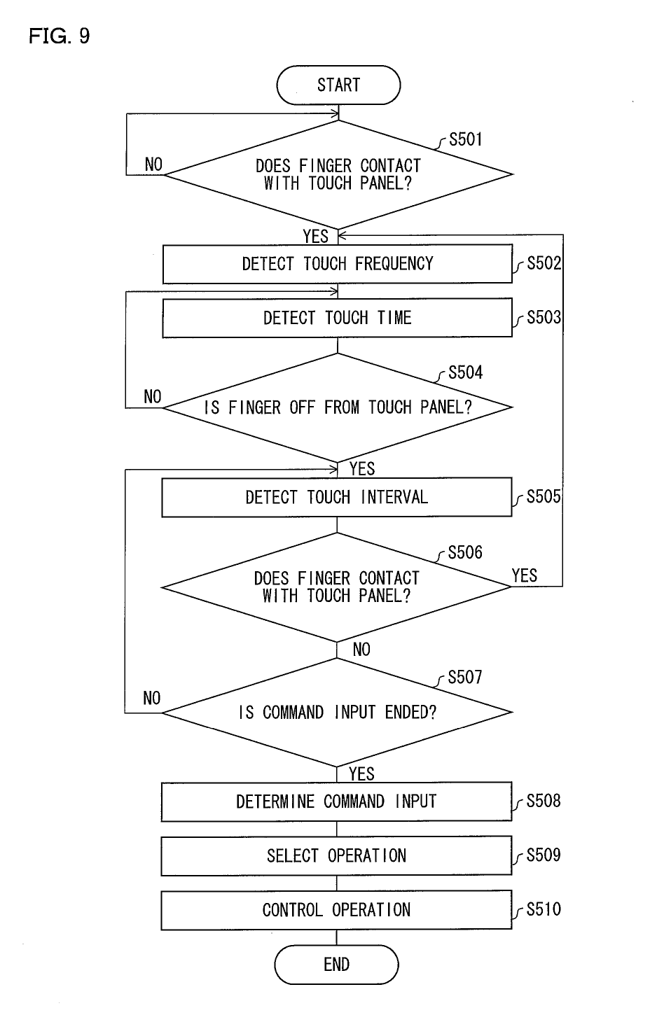

### DESCRIPTION OF EMBODIMENTS

### Embodiment 1

### Configuration of Touch Panel System 1

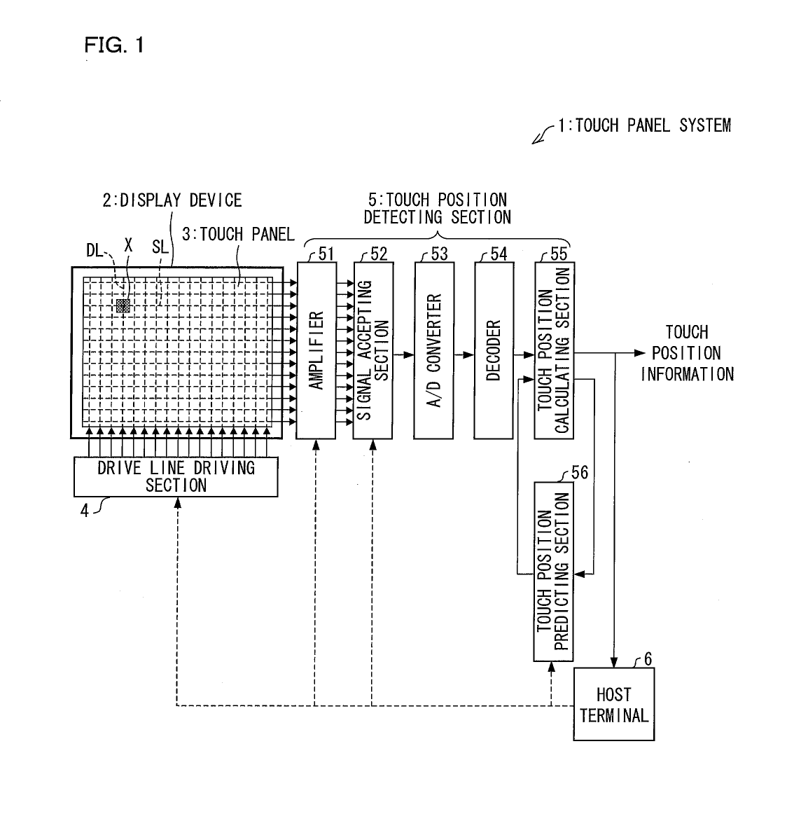

The following discusses embodiments of the present invention in detail. FIG. 1 is a view schematically illustrating a basic configuration of a touch panel system 1 according to Embodiment 1 of the present invention. As illustrated in FIG. 1, the touch panel system 1 includes a display device 2, a touch panel 3, a drive line driving section 4, a touch position detecting section 5, and a host terminal 6. The following description assumes that a side on which a user carries out a touch operation is a front surface (or an upper side).

The display device 2 has a display surface on which various icons for operations, character information corresponding to operational instructions by the user, and the like are to be displayed. The display device 2 is made up of, for example, a liquid crystal display, a plasma display, an organic EL display, a field emission display (FED), or the like. These displays are widely used in electronic devices for daily use, so that the touch panel system 1 has high versatility. The display device 2 can be arbitrarily configured, and an arrangement of the display device 2 is not specifically limited.

To the touch panel 3, the user inputs various operational instructions by carrying out a touch (push) operation with respect to a surface of the touch panel 3 with an indicator such as his/her finger or a pen. The touch panel 3 is stacked on the front surface (upper surface) of the display device 2 so as to cover the display surface of the display device 2. In the present embodiment, a projected capacitive type touch panel is used as the touch panel 3. The capacitive touch panel 3 has advantages such as high light transmittance and high durability. However, a type of the touch panel 3 is not limited to the projected capacitive type and can be another type. The type of the touch panel 3 can be, for example, a resistive film type, an electromagnetic inductive type, an ultrasonic surface acoustic wave type, or an infrared scanning type.

Specifically, the touch panel 3 includes a plurality of drive lines DL which are provided along the display surface so as to be parallel to each other, and a plurality of sense lines SL which are provided along the display surface so as to be parallel to each other and intersect with the plurality of drive lines DL in a grade separation manner. At each of intersections of the plurality of drive lines DL and the plurality of sense lines SL, a capacitor is formed. The plurality of drive lines DL and the plurality of sense lines SL can be made of, for example, (i) a transparent wiring material such as indium tin oxide (ITO) or (ii) a metallic mesh. The plurality of drive lines DL and the plurality of sense lines SL are connected to the display device 2 (a panel unit which constitutes a part of the display surface). Note that FIG. 1 deals with an example in which the plurality of drive lines DL and the plurality of sense lines SL vertically intersect with each other in a grade separation manner, but the plurality of drive lines DL and the plurality of sense lines SL can alternatively intersect with each other in a grade separation manner at any angle other than a vertical direction.

The drive line driving section 4 is connected with the plurality of drive lines DL and, when the touch panel system 1 is activated, the drive line driving section 4 applies electrical potentials to the plurality of the drive lines DL at constant intervals. The drive line driving section 4 causes the plurality of sense lines SL, which intersect with the plurality of drive lines DL in the grade separation manner, to generate condition signals by driving the plurality of drive lines DL. The condition signal is a signal which indicates a condition of a touch at or near the intersections (hereinafter, referred to as a “detection region” (detection region X illustrated in FIG. 1)) of the plurality of drive lines DL and the plurality of sense lines SL on the touch panel 3.

A value of the condition signal varies in accordance with the capacitance between the drive line DL and the sense line SL, and indicates whether the indicator is in contact with or is being near to the detection region X on the touch panel 3. That is, the condition signal indicates (i) the presence or absence of the indicator being in contact with or being near to the detection region X, (ii) a distance between the detection region X and the indicator, or the like. Note that, as the indicator comes closer to the detection region X or when the indicator is in contact with the detection region X, the capacitance becomes smaller.

The touch position detecting section 5 processes a signal supplied from the touch panel 3 so as to detect a touch position. That is, the touch position detecting section 5 detects a position of the touch by the indicator, which is in contact with or is being near to the display surface, by processing the condition signal generated on the sense line SL. The touch position detecting section 5 includes, from a touch panel 3 side, an amplifier 51, a signal accepting section 52, an A/D converter 53, a decoder 54, a touch position calculating section 55, and a touch position predicting section 56 in this order.

The amplifier 51 amplifies the condition signals generated on the plurality of sense lines SL. The signal accepting section 52 accepts the condition signals amplified by the amplifier 51 and supplies the amplified condition signals in a time division manner. The A/D converter 53 converts the condition signals, which have been supplied from the signal accepting section 52 and are analog signals, into respective digital signals. The decoder 54 calculates, on the basis of the digital signals converted by the A/D converter 123, a changed amount of capacity distribution in the touch panel 3. The touch position calculating section 55 calculates, on the basis of the changed amount of the capacity distribution calculated by the decoder 54, a position of the touch on the touch panel 3, and then generates touch position information indicative of the calculated position of the touch. The touch position predicting section 56 predicts a touch position based on a touch operation record. That is, the touch position predicting section 56 predicts a current touch position based on a record relating to a previous touch operation. The touch position predicting section 56 will be described later in detail.

The host terminal 6 controls the plurality of drive lines DL which are driven by the drive line driving section 4. The host terminal 6 also controls the plurality of sense lines SL which generate the condition signals to be processed by the touch position detecting section 5. The following description deals with an example in which the host terminal 6 controls the plurality of drive lines DL and the plurality of sense lines SL. Note, however, that the host terminal 6 can alternatively control only the plurality of drive lines DL or the plurality of sense lines SL.

(Basic Operation of Touch Panel System 1)

Next, the following discusses an example of a basic operation of the touch panel system 1 with reference to FIG. 1. Note that the following discusses a single trial operation in which the touch panel system 1 detects an indicator that is in contact with or is being near to the touch panel 3.

First, the drive line driving section 4 drives the plurality of drive lines DL so that condition signals are generated on the plurality of sense lines SL. Next, the amplifier 51 amplifies the condition signals generated on the plurality of sense lines SL. Further, the signal accepting section 52 supplies the condition signals, which have been amplified by the amplifier 51, in a time division manner. Note that the host terminal 6 controls operation of each of the drive line driving section 4, the amplifier 51, and the signal accepting section 52. That is, the host terminal 6 controls the plurality of drive lines DL to be driven and the plurality of sense lines SL on which condition signals to be processed are generated.

Next, the A/D converter 53 converts the analog signals, which have been supplied from the signal accepting section 52, into respective digital signals each having a predetermined number of bits. Subsequently, the decoder 54 calculates, on the basis of the digital signals converted by the A/D converter 53, a changed amount of capacity distribution in the touch panel 3. For example, before a touch operation is detected, the decoder 54 obtains digital signals indicative of a case where a touch subject (indicator) does not exist on the touch panel 3 and calculates in advance capacity distribution of the case where the touch subject (indicator) does not exist on the touch panel 3. The decoder 54 then receives from the A/D converter 53 digital signals indicative of a case where the indicator has been detected and calculates capacity distribution of the case where the indicator is present. After that, the decoder 54 compares the pre-calculated capacity distribution of the case where the touch subject is absent with the capacity distribution of the case where the touch subject is present, so as to calculate a changed amount of the capacity distribution. This changed amount of the capacity distribution can be rephrased as an amount by which capacitance is changed due to the touch subject (indicator).

The touch position calculating section 55 calculates, on the basis of the changed amount of the capacity distribution calculated by the decoder 54, a position of the touch subject on the touch panel 3, and generates touch position information. The touch position calculating section 55 calculates the position of the touch subject on the touch panel 3 by, for example, determining that the touch subject exists at a position at which the changed amount of the capacitance is larger than a threshold for determining a touch.

The touch position predicting section 56 sets predicted coordinates of a touch position or a predicted range of a touch position based on a touch operation record, and the touch position predicting section 56 predicts, based on the predicted coordinates or the predicted range, a touch position from touch position candidates detected by the touch position detecting section 5.

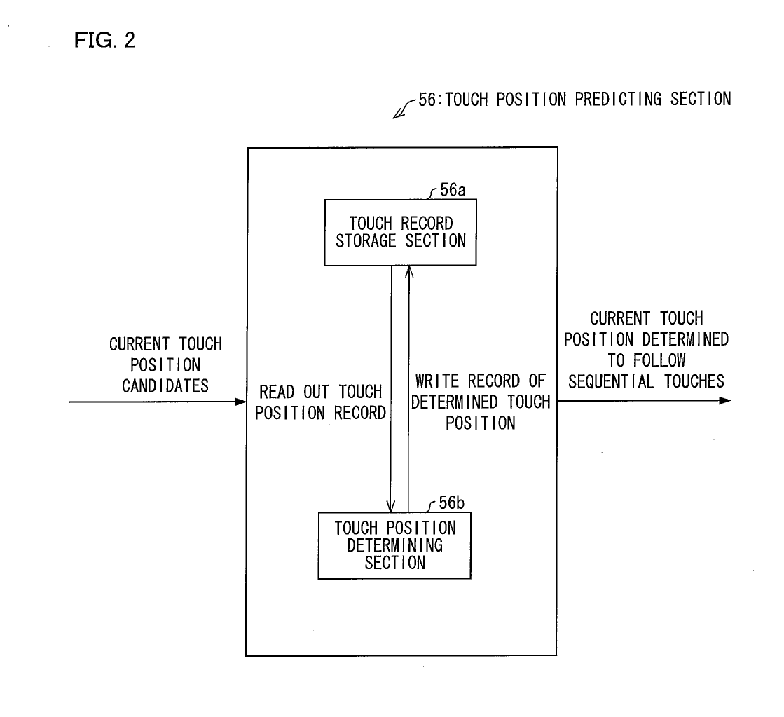

The following description will discuss an example of the touch position predicting section 56 with reference to FIG. 2. FIG. 2 is a block diagram illustrating a configuration of the touch position predicting section 56 included in the touch panel system 1 illustrated in FIG. 1. As illustrated in FIG. 2, the touch position predicting section 56 includes a touch record storage section 56a and a touch position determining section 56b.

The touch record storage section 56a stores (i) relative time of the touch position calculated by the touch position calculating section 55 and (ii) position information of the touch position (such as coordinates of the touch position). The touch record storage section 56a also stores a record of a previous touch position. Therefore, in the touch panel system 1, the touch record storage section 56a stores a touch position moving speed (touch speed) and a touch position movement acceleration, which are calculated based on a record of the touch operation. Note that the touch record storage section 56a (i) calculates a touch position moving speed based on a distance and a moving time between arbitrary two points, and (ii) calculates a movement acceleration based on the moving speed of continuous touch positions. Moreover, touch positions calculated by the touch position calculating section 55 include an erroneously recognized touch position which has been caused by noise.

The touch position determining section 56b sets predicted coordinates or a predicted range of a touch position based on a touch operation record stored in the touch record storage section 56a. Further, the touch position determining section 56b determines a touch position based on a result of comparing (i) a touch position candidate detected by the touch position detecting section 5 with (ii) the predicted coordinates or the predicted range thus set. For example, the touch position determining section 56b calculates predicted coordinates or a predicted range in consideration of a direction in which a touch position moves and a distance by which the touch position moves, based on a touch position, a touch position moving speed, and a touch position movement acceleration which are included in a previous touch record read out from the touch record storage section 56a. Then, the touch position determining section 56b compares a touch position candidate (current touch position) with the predicted coordinates or the predicted range, and thus calculates (i) how near the touch position candidate is to the predicted coordinates or (ii) whether or not the touch position candidate exists in the predicted range. From this, a touch position by the indicator is determined from the touch position candidates detected by the touch position calculating section 55. The process of the touch position determining section 56b will be described later.

The touch panel system 1 continuously detects the indicator that is the touch subject by repeating the trial operation described above.

With reference to the touch position information supplied from the touch position calculating section 55 as necessary, the host terminal 6 can control each section of the drive line driving section 4 and the touch position detecting section 5. Further, the host terminal 6 can control a frame rate, which is the number of times that the touch position detecting section 5 attempts to detect a touch subject per unit time (e.g., per second). That is, in the touch panel system 1, the host terminal 6 can arbitrarily control settings of (i) the plurality of drive lines DL which are supposed to be driven by the drive line driving section 4, (ii) the plurality of sense lines SL on which the condition signals to be processed by the touch position detection section 5 are supposed to be generated, (iii) the frame rate, (iv) detection sensitivity, and the like.

(Process of Touch Position Predicting Section 56)

Next, the following discusses in detail the touch position predicting section 56 which is a characteristic feature of the touch panel system 1. In the touch panel system 1, the touch position detecting section 5 detects a touch position at every predetermined time, so that a touch position (current touch position) at a certain time point is recognized. Thus, in a case where noise has occurred on the touch panel 3, not only a touch position that is supposed to be recognized but also a position of the noise is recognized as touch positions. That is, in a case where the noise is included, a plurality of touch position candidates are detected by the touch position calculating section 55. As a result, noise which has occurred at a position far distant from a touch position record is erroneously recognized as a touch position candidate. That is, a touch phenomenon caused by the noise is erroneously recognized as a touch position candidate.

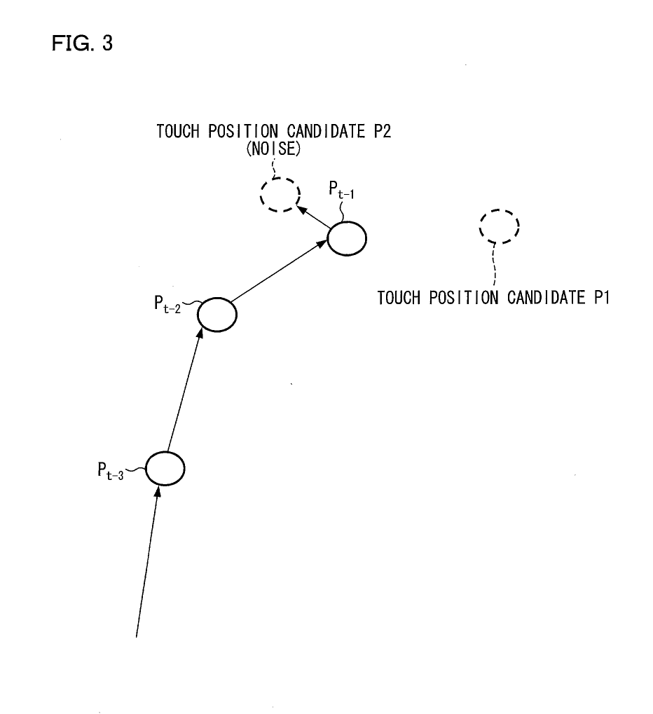

For example, FIG. 3 is a view illustrating a method of predicting coordinates of a touch position by the touch panel system 1 illustrated in FIG. 1 based on a distance from a previous touch position. FIG. 3 illustrates a state in which sequential touch operations are carried out in an order of a touch position Pₜ₋₃→a touch position Pₜ₋₂→a touch position Pₜ₋₁, and two touch position candidates (i.e., a touch position candidate P1 and a touch position candidate P2) are detected by the touch position calculating section 55 at a certain time (t). The touch position Pₜ₋₁, the touch position Pₜ₋₂, and the touch position Pₜ₋₃ are respective touch positions detected one through three times before the certain time (t). Moreover, the touch position candidate P1 is a touch position of the indicator, and the touch position candidate P2 is a touch position caused by noise.

In the case of FIG. 3, comparison between the touch position candidate P1 and the touch position candidate P2 at the certain time (t) shows that the touch position candidate P2 which is the touch position caused by the noise is nearer to the previous touch position Pₜ₋₁ previous to the certain time (t) than is the touch position candidate P1 which is the touch position of the indicator. Therefore, if the touch position predicting section 56 predicts the touch position at the certain time (t) based only on a distance element from the touch position Pₜ₋₁ (i.e., near-to or far-from the touch position Pₜ₋₁), the touch position candidate P2 which is near to the previous touch position Pₜ₋₁ is to be determined as a touch position. Therefore, the touch position caused by the noise (i.e., the touch position candidate P2) is erroneously recognized as the touch position at the certain time (t). That is, in view of the touch operation record, a touch phenomenon that is caused by noise, etc. appearing in an unnatural direction is erroneously recognized as a touch position.

In order to prevent such erroneous recognition, the touch panel system 1 includes the touch position predicting section 56. The touch position predicting section 56 removes the noise and predicts a correct touch position based on a touch operation record.

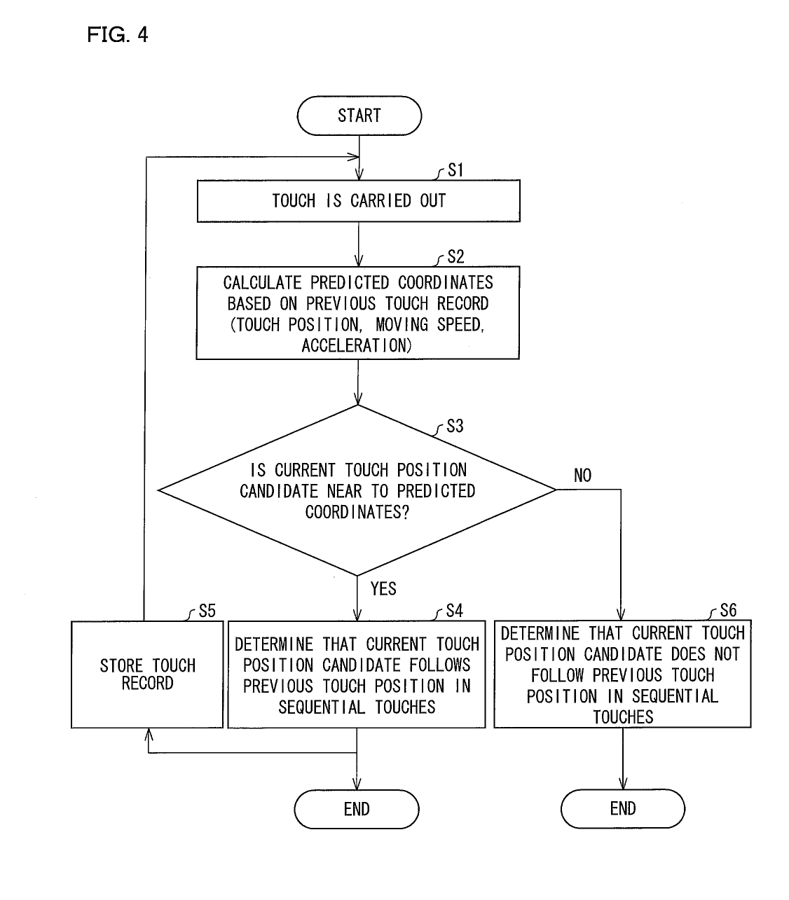

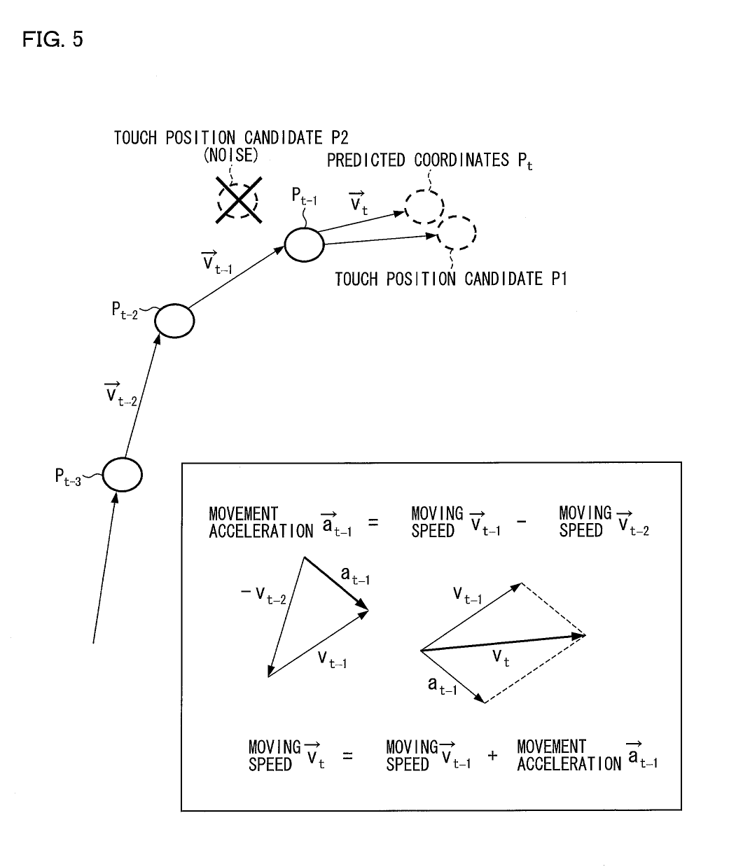

The following discusses, with reference to FIGS. 4 and 5, an example in which the touch position predicting section 56 determines a touch position on the basis of a touch operation record. FIG. 4 is a flowchart illustrating a process of the touch position predicting section 56 of the touch panel system 1 illustrated in FIG. 1. FIG. 5 is a view schematically illustrating the process of the touch position predicting section 56 of the touch panel system 1 illustrated in FIG. 1.

As described above, the touch position detecting section 5 processes a signal supplied from the touch panel 3 so as to detect a touch position. Specifically, when a touch operation is carried out with respect to the touch panel 3 (S1), the touch position calculating section 55 calculates a current touch position on the basis of a changed amount of capacitance of the touch panel 3, and supplies a result of the calculation to the touch position predicting section 56 (see FIG. 4). The current touch position has not been processed by the touch position predicting section 56, and is therefore a touch position candidate that may include noise. In the touch position predicting section 56, the touch position determining section 56b calculates predicted coordinates of a touch position based on a touch operation record stored in the touch record storage section 56a. Here, the touch position determining section 56b calculates predicted coordinates of a touch position based on (a) previous touch position, (b) a previous touch position moving speed, and (c) a previous touch position movement acceleration, with respect to the current touch position (S2).

The following discusses determination of the touch position determining section 56b with reference to FIG. 5. In the example of FIG. 5, as with FIG. 3, a touch position Pₜ₋₁, a touch position Pₜ₋₂, and a touch position Pₜ₋₃ are described as respective touch positions detected one through three times before the certain time (t). Moreover, a touch position candidate P1 and a touch position candidate P2 are described as respective two touch position candidates detected by the touch position calculating section 55 at the certain time (t). Further, a position of predicted coordinates calculated by the touch position determining section 56b at the certain time (t) is described as predicted coordinates Pt. Further, a touch position moving speed Vₜ₋₂ from the touch position Pₜ₋₃ to the touch position Pₜ₋₂, a touch position moving speed Vₜ₋₁ from the touch position Pₜ₋₂ to the touch position Pₜ₋₁, and a touch position moving speed Vₜ from the touch position Pₜ₋₁ to the predicted coordinates Pt are described as the touch position moving speeds.

The touch position moving speed is calculated based on a distance and a moving time between arbitrary two touch positions. A movement acceleration aₜ₋₁ from the touch position Pₜ₋₂ to the touch position Pₜ₋₁ is calculated based on a difference between the touch position moving speed Vₜ₋₂ and the touch position moving speed Vₜ₋₁ (i.e., the movement acceleration aₜ₋₁=the touch position moving speed Vₜ₋₂−the touch position moving speed Vₜ₋₂). Further, the predicted coordinates Pt are calculated based on the touch position, the touch position moving speed, and the touch position movement acceleration. That is, the predicted coordinates Pt are calculated on the basis of a prediction that a touch position (current touch position) at the certain time (t) has moved from the touch position Pₜ₋₁ at the moving speed Vₜ and with the movement acceleration aₜ₋₁ (i.e., predicted coordinates Pt=touch position moving speed Vₜ₋₁+touch position movement acceleration aₜ₋₁). The touch position moving speed and the movement acceleration are calculated by the touch record storage section 56a and is stored in the touch record storage section 56a. The predicted coordinates Pt are calculated by the touch position determining section 56b with the use of values stored in the touch record storage section 56a.

The touch position determining section 56b classifies, based on the predicted coordinates Pt, each of the touch position candidates P1 and P2 into a touch position that is supposed to be detected (i.e., position of an indicator such as a finger or a pen) or a position that should not be detected (i.e., noise). For example, in the examples of FIG. 4 and FIG. 5, the touch position determining section 56b determines which one of the current touch position candidates P1 and P2 is nearer to the predicted coordinates Pt (S3). In FIG. 5, the touch position candidate P1 is nearer to the predicted coordinates Pt than the touch position candidate P2 is. Therefore, the touch position candidate P1 is determined to follow sequential touches in an order of the touch position Pₜ₋₃→the touch position Pₜ₋₂→the touch position Pₜ₋₁ (S4). Then, a touch position of the touch position candidate P1, a touch position moving speed from the touch position Pₜ₋₁ to the touch position candidate P1, and a touch position movement acceleration from the touch position to the touch position candidate P1 are stored in the touch record storage section 56a (S5).

Meanwhile, the touch position candidate P2 is farther from the predicted coordinates Pt than the touch position candidate P1 is. Therefore, the touch position candidate P2 is not regarded as following the sequential touches in the order of the touch position Pₜ₋₃→the touch position Pₜ₋₂→the touch position Pₜ₋₁. That is, the touch position candidate P2 is determined to be a touch phenomenon caused by noise and is excluded from the touch position candidates (S6).

As such, in the touch panel system 1 of the present embodiment, the touch position predicting section 56 distinguishes a touch position of the indicator and a touch position (touch phenomenon) caused by noise, on the basis of the predicted coordinates Pt which have been set based on a touch operation record. It is therefore possible to prevent erroneous recognition that is caused in a case where a touch position is determined based only on a distance element from the touch position Pₜ₋₁ (i.e., near-to or far-from the touch position Pₜ₋₁). That is, it is possible to prevent the touch position candidate P2, which has been caused by noise, from being determined to be a current touch position.

In the example described above, a touch position is determined from two touch position candidates (i.e., the touch position candidates P1 and P2). Note, however, that, in a case where there are three or more touch position candidates, a touch position candidate that is nearest to the predicted coordinates Pt can be determined as a touch position.

### Embodiment 2

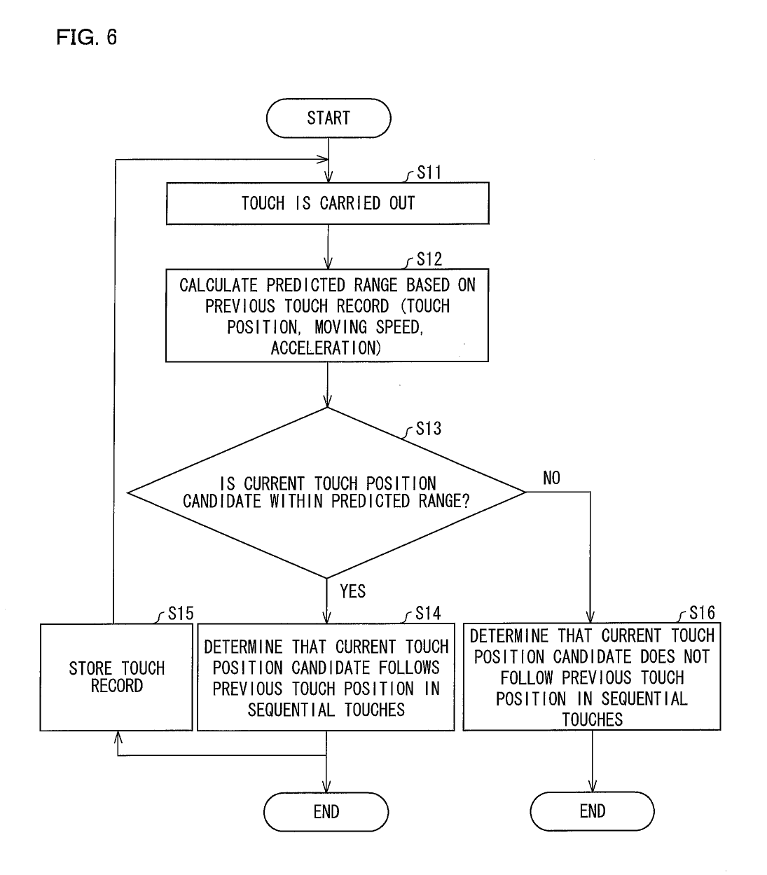

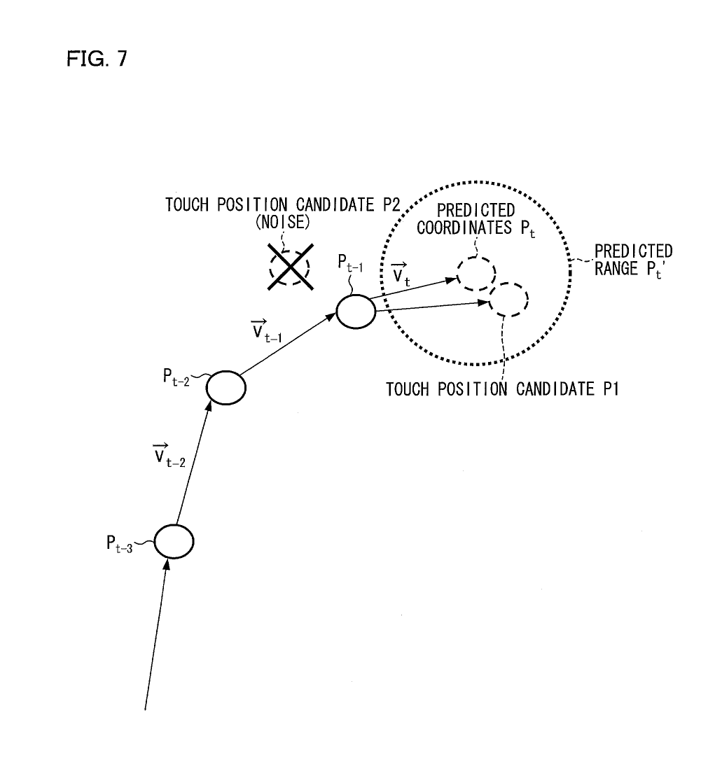

The following description will discuss another embodiment of the present invention with reference to FIGS. 6 and 7. Note that, for convenience, identical reference numerals are given to members having respective functions identical to those of the members described in Embodiment 1, and descriptions of those members are omitted in Embodiment 2. Further, the following particularly discusses a difference from Embodiment 1, i.e., a process of the touch position predicting section 56.

(Another Process of Touch Position Predicting Section 56)

In Embodiment 1, the touch position predicting section 56 sets the predicted coordinates Pt of one point so as to determine a touch position. In Embodiment 2, the touch position predicting section 56 sets a predicted range Pt′, whose center is at predicted coordinates Pt, so as to determine a touch position.

FIG. 6 is a flowchart illustrating a process of the touch position predicting section 56 of the touch panel system 1 according to Embodiment 2 of the present invention. FIG. 7 is a view schematically illustrating a process (coordinates predicting method) of the touch position predicting section 56 of the touch panel system 1 according to Embodiment 2 of the present invention.

Specifically, when a touch operation is carried out with respect to the touch panel 3 (S11), the touch position calculating section 55 calculates a current touch position on the basis of a changed amount of capacitance of the touch panel 3, and supplies a result of the calculation to the touch position predicting section 56 (see FIG. 6). This current touch position has not been subjected to the process of the touch position predicting section 56, and therefore the current touch position is a touch position candidate that may include noise. In the touch position predicting section 56, the touch position determining section 56b (i) calculates predicted coordinates of a touch position based on a touch operation record stored in the touch record storage section 56a, and (ii) calculates a predicted range whose center is at the predicted coordinates thus calculated. Here, the predicted coordinates and the predicted range are calculated on the basis of (a) a previous touch position, (b) a previous touch position moving speed, and (c) a previous touch position movement acceleration, with respect to the current touch position (S12).

The following discusses determination of the touch position determining section 56b with reference to FIG. 7. In the example of FIG. 7, as with FIG. 5, a touch position Pₜ₋₁, a touch position Pₜ₋₂, and a touch position Pₜ₋₃ are described as respective touch positions detected one through three times before the certain time (t). Moreover, a touch position candidate P1 and a touch position candidate P2 are described as respective two touch position candidates detected by the touch position calculating section 55 at the certain time (t). Further, a position of predicted coordinates calculated by the touch position determining section 56b at the certain time (t) is described as predicted coordinates Pt. Further, a touch position moving speed Vₜ₋₂ from the touch position Pₜ₋₃ to the touch position Pₜ₋₂, a touch position moving speed Vₜ₋₁ from the touch position Pₜ₋₂ to the touch position Pₜ₋₁, and a touch position moving speed Vₜ from the touch position Pₜ₋₁ to the predicted coordinates Pt are described as the touch position moving speeds. Further, a predicted range Pt′ is described whose center is at the predicted coordinates Pt.

In the example of FIG. 7, the predicted range Pt′ is set as a circle whose center is at the predicted coordinates Pt. Note, however, that a method for setting the predicted range Pt′ is not limited to such a circle. That is, the predicted range Pt′ can be set on the basis of a touch operation record, i.e., previous touch information. For example, as with the predicted coordinates Pt, the predicted range Pt′ can be set on the basis of (a) a previous touch position, (b) a previous touch position moving speed, and (c) a previous touch position movement acceleration, with respect to the current touch position.

The touch position determining section 56b classifies, based on the predicted range Pt′, each of the touch position candidates P1 and P2 into a touch position that is supposed to be detected (i.e., position of an indicator such as a finger or a pen) or a position that should not be detected (i.e., noise). For example, in the examples of FIG. 6 and FIG. 7, the touch position determining section 56b determines which one of the current touch position candidates P1 and P2 is within the predicted range Pt′ (S13). In FIG. 7, the touch position candidate P1 is within the predicted range Pt′. Therefore, the touch position candidate P1 is determined to follow sequential touches in the order of the touch position Pₜ₋₃→the touch position Pₜ₋₂→the touch position Pₜ₋₁ (S14). Then, a touch position of the touch position candidate P1, a touch position moving speed from the touch position Pₜ₋₁ to the touch position candidate P1, and a touch position movement acceleration from the touch position Pₜ₋₁ to the touch position candidate P1 are stored in the touch record storage section 56a (S15).

Meanwhile, the touch position candidate P2 is out of the predicted range Pt′. Therefore, the touch position candidate P2 is not regarded as following the sequential touches in the order of the touch position Pₜ₋₃→the touch position Pₜ₋₂→the touch position Pₜ₋₁. That is, the touch position candidate P2 is determined to be a touch phenomenon caused by noise and is excluded from the touch position candidates (S16).

As such, in the touch panel system 1 of the present embodiment, the touch position predicting section 56 distinguishes a touch position of the indicator and a touch position (touch phenomenon) caused by noise, on the basis of the predicted range Pt′ which has been set based on a touch operation record. It is therefore possible to prevent erroneous recognition that is caused in a case where a touch position is determined based only on a distance element from the touch position Pₜ₋₁ (i.e., near-to or far-from the touch position Pₜ₋₁). That is, it is possible to prevent the touch position candidate P2, which has been caused by noise, from being determined to be a current touch position.

In the example described above, only the touch position candidate P1 is within the predicted range Pt′. Note, however, that, in a case where a plurality of touch position candidates exist in the predicted range Pt′, a touch position candidate that is nearest to the center of the predicted range Pt′ (i.e., the predicted coordinates Pt) can be determined as a touch position.

### Embodiment 3

FIG. 10 is a functional block diagram illustrating a configuration of a mobile phone 10 including the touch panel system 1. The mobile phone (electronic device) 10 includes a CPU 71, a RAM 73, a ROM 72, a camera 74, a microphone 75, a speaker 76, an operation key 77, and the touch panel system 1. These components are connected to each other via a data bus.

The CPU 71 controls an operation of the mobile phone 10. The CPU 71 executes a program stored in, for example, the ROM 72. The operation key 77 is used by a user of the mobile phone 10 to enter instructions. The RAM 73 is a volatile memory which stores therein (i) data generated when the CPU 71 has executed the program or (ii) data entered via the operation key 77. The ROM 72 is an involatile memory which stores data therein.

The ROM 72 is a ROM, such as an erasable programmable read-only memory (EPROM) or a flash memory, into which data can be written or from which data can be deleted. Note that, although not illustrated in FIG. 10, the mobile phone 10 can have an interface (IF) for being connected with another electronic apparatus via a wire.

The camera 74 takes an image of a subject in accordance with a user's operation of the operation key 77. Note that the image data of the subject thus taken is stored in the RAM 73 or an external memory (e.g., a memory card). The microphone 75 accepts audio from a user. The mobile phone 10 digitizes the audio (analog data) thus accepted, and transmits the audio thus digitized to a destination (such as other mobile phone). The speaker 76 outputs sounds based on data such as music data stored in the RAM 73.

The CPU 71 controls an operation of the touch panel system 1. The CPU 71 executes a program stored in, for example, the ROM 72. The RAM 73 is a volatile memory which stores therein data generated when the CPU 71 has executed the program. The ROM 72 is an involatile memory which stores data therein. The touch panel system 1 displays images stored in the ROM 72 and/or in the RAM 73.

Further, the present invention can be described as the following.

[Main Points]

The touch panel system 1 in accordance with an aspect of the present invention includes: a touch panel 3; and a touch position detecting section 5 for detecting a touch position on the touch panel 3, the touch position detecting section 5 including: a touch position predicting section 56 for (i) setting predicted coordinates Pt or a predicted range Pt′ of a touch position based on a touch operation record and (ii) predicting a touch position from touch position candidates, which have been detected by the touch position detecting section 5, based on the predicted coordinates Pt or the predicted range Pt′.

According to the configuration, the touch position predicting section 56 (i) predicts, based on a touch operation record, a direction in which a touch position moves and a distance by which the touch position moves and (ii) sets predicted coordinates Pt or a predicted range Pt′ of the touch position. Further, the touch position predicting section 56 predicts a touch position based on the predicted coordinates Pt or the predicted range Pt′. From this, in a case where a touch position recognized at a certain time point is extremely different from the touch operation record, the touch position is far distant from the predicted coordinates Pt or the predicted range Pt′. Thus, a touch position that is supposed to be detected (i.e., position of an indicator such as a finger or a pen) is distinguished from a position that should not be detected (noise). Consequently, it is possible to remove noise from touch position candidates (touch position candidates P1 and P2) which have been detected by the touch position detecting section 5. It is therefore possible to prevent erroneous recognition of a touch position.

According to the touch panel system 1 of an aspect of the present invention, the touch position predicting section preferably sets the predicted coordinates Pt or the predicted range Pt′ based on a touch position, a touch position moving speed, and a touch position movement acceleration.

According to the configuration, the touch position predicting section 56 sets the predicted coordinates Pt or the predicted range Pt′ based on a touch position, a touch position, a touch position moving speed, and a touch position movement acceleration as the touch operation record. From this, a process of setting the predicted coordinates Pt or the predicted range Pt′ is simplified. Moreover, accuracy of the predicted coordinates Pt or the predicted range Pt′ is heightened. It is therefore possible to rapidly remove noise from touch position candidates with high accuracy.

According to the touch panel system 1 in accordance with an aspect of the present invention, it is preferable that the touch position predicting section 56 includes a touch position determining section 56b for determining a touch position based on a result of comparing (i) the touch position candidates (touch position candidates P1 and P2) detected by the touch position detecting section 5 with (ii) the predicted coordinates Pt or the predicted range Pt′; and the touch position determining section 56b determines that a touch position candidate which is relatively near to the predicted coordinates Pt or is within the predicted range Pt′ is a touch position.

According to the configuration, in a case where touch position candidates (touch position candidates P1 and P2) have been detected by the touch position detecting section 5, the touch position determining section 56b compares the touch position candidates with the predicted coordinates Pt or the predicted range Pt′, and determines that a touch position candidate which is relatively near to the predicted coordinates Pt or is within the predicted range Pt′ is a touch position. It is therefore possible to correctly recognize a touch position.

According to the touch panel system 1 in accordance with an aspect of the present invention, it is preferable that the touch position predicting section 56 includes a touch position determining section 56b for determining a touch position based on a result of comparing (i) the touch position candidates (touch position candidates P1 and P2) detected by the touch position detecting section 5 with (ii) the predicted coordinates Pt or the predicted range Pt′; and the touch position determining section 56b excludes, from the touch position candidates, a touch position candidate which is relatively far from the predicted coordinates Pt or is out of the predicted range Pt′.

According to the configuration, in a case where touch position candidates (touch position candidates P1 and P2) have been detected by the touch position detecting section 5, the touch position determining section 56b compares the touch position candidates with the predicted coordinates Pt or the predicted range Pt′, and excludes, from the touch position candidates, a touch position candidate which is relatively far from the predicted coordinates Pt or is within the predicted range Pt′. It is therefore possible to correctly recognize a touch position.

According to the touch panel system 1 in accordance with an aspect of the present invention, it is preferable that the touch position predicting section 56 includes a touch position determining section 56b for determining a touch position based on a result of comparing (i) the touch position candidates (touch position candidates P1 and P2) detected by the touch position detecting section 5 with (ii) the predicted coordinates Pt or the predicted range Pt′; and the touch position determining section 56b determines that a touch position candidate which is nearest to the predicted coordinates Pt or is nearest to a center of the predicted range Pt′ is a touch position.

According to the configuration, in a case where touch position candidates (touch position candidates P1 and P2) have been detected by the touch position detecting section 5, the touch position determining section 56b compares the touch position candidates with the predicted coordinates Pt or the predicted range Pt′, and determines that a touch position candidate which is nearest to a center of the predicted range Pt′ or the predicted coordinates Pt is a touch position. That is, the other touch position candidates are excluded from the touch position candidates. It is therefore possible to correctly recognize a touch position.

The touch panel system 1 according to an aspect of the present invention can be arranged such that the touch panel is a projected capacitive type touch panel.

According to the above configuration, since the touch panel system 1 includes the touch panel whose operation principle is the projected capacitive type, it is possible to provide a touch panel system capable of accepting multi-touch (multi-point detection).

The touch panel system 1 according to an aspect of the present invention can further include a display device and can be arranged such that the touch panel is provided on a front surface of the display device.

According to the arrangement, since the touch panel is provided on the front surface of the display device, it is possible to prevent erroneous recognition of noise as a touch position which noise has occurred in the display device.

The touch panel system 1 according to an aspect of the present invention can be arranged such that the display device is a liquid crystal display, a plasma display, an organic EL display, or a field emission display.

According to the above configuration, the display device is made up of any of the above displays that are widely used in electronic devices for daily use. This makes it possible to provide a touch panel system having high versatility.

An electronic device according to an aspect of the present invention includes any one of the above described touch panel systems.

Therefore, it is possible to provide an electronic device that can prevent erroneous recognition of a touch operation.

The present invention is not limited to the embodiments, but can be altered by a skilled person in the art within the scope of the claims. An embodiment derived from a proper combination of technical means disclosed in respective different embodiments is also encompassed in the technical scope of the present invention. Further, it is possible to form a new technical feature by combining the technical means disclosed in the respective embodiments.

### INDUSTRIAL APPLICABILITY

The present invention is applicable to various electronic devices each of which includes a touch panel.

The various electronic devices encompass a television, a personal computer, a mobile phone, a digital camera, a portable game device, an electronic photo frame, a mobile information terminal, an electronic book, household electric appliances, a ticket vending machine, an ATM, a car navigation device, and the like.

### REFERENCE SIGNS LIST

1 Touch Panel System
2 Display Device
3 Touch Panel
4 Drive Line Driving Section
5 Touch Position Detecting Section
10 Mobile Phone (Electronic Device)
56 Touch Position Predicting Section
56b Touch Position Determining Section

1.-7. (canceled)

8. A touch panel system comprising:
a touch panel; and
a touch position detecting section for detecting a touch position on the touch panel,
the touch position detecting section including:
a touch position predicting section for (i) setting predicted coordinates or a predicted range of a touch position based on a touch operation record and (ii) determining a touch position from touch position candidates, which have been detected by the touch position detecting section, based on the predicted coordinates or the predicted range,
the touch position predicting section setting the predicted coordinates or the predicted range based on a touch position, a touch position moving speed, and a touch position movement acceleration,
the touch position predicting section including a touch position determining section for determining a touch position based on a result of comparing (i) the touch position candidates detected by the touch position detecting section with (ii) the predicted coordinates or the predicted range, and
in a case where a plurality of touch position candidates have been detected at a certain time point, the touch position determining section determining that a touch position candidate which is relatively near to the predicted coordinates or is within the predicted range is a touch position.

9. The touch panel system as set forth in claim 8, wherein:
the touch position determining section excludes, from the touch position candidates, a touch position candidate which is relatively far from the predicted coordinates or is out of the predicted range.

10. The touch panel system as set forth in claim 8, wherein:
the touch position determining section determines that a touch position candidate which is nearest to the predicted coordinates or is nearest to a center of the predicted range is a touch position.

11. A touch panel system comprising:
a touch panel; and
a touch position detecting section for detecting a touch position on the touch panel,
the touch position detecting section including:
a touch position predicting section for (i) setting predicted coordinates or a predicted range of a touch position based on a touch operation record and (ii) determining a touch position from touch position candidates, which have been detected by the touch position detecting section, based on the predicted coordinates or the predicted range,
the touch position predicting section setting the predicted coordinates or the predicted range based on a touch position, a touch position moving speed, and a touch position movement acceleration,
the touch position predicting section including a touch position determining section for determining a touch position based on a result of comparing (i) the touch position candidates detected by the touch position detecting section with (ii) the predicted coordinates or the predicted range, and
in a case where a plurality of touch position candidates have been detected at a certain time point, the touch position determining section determining that a touch position candidate which is nearest to the predicted coordinates or is nearest to a center of the predicted range is a touch position.

12. The touch panel system as set forth in claim 11, wherein:
the touch position determining section excludes, from the touch position candidates, a touch position candidate which is relatively far from the predicted coordinates or is out of the predicted range.

13. The touch panel system as set forth in claim 9, wherein:
the touch position determining section determines that a touch position candidate which is nearest to the predicted coordinates or is nearest to a center of the predicted range is a touch position.
